(19) United States
(12) Patent Application Publication
(10) Pub. No.: US 2014/0324669 A1
(43) Pub. Date: Oct. 30, 2014

(54) SYSTEM, SERVER AND METHOD FOR PROCESSING DATA RECORDS REPRESENTING FINANCIAL INSTRUMENTS

(71) Applicant: FTSE TMX GLOBAL CAPITAL MARKETS INC., Toronto (CA)

(72) Inventor: John George Bruce McLean, Toronto (CA)

(21) Appl. No.: 14/361,909

(22) PCT Filed: Dec. 4, 2012
(86) PCT No.: PCT/CA2012/001115

§ 371 Date: May 30, 2014

Related U.S. Application Data
(60) Provisional application No. 61/566,772, filed on Dec. 5, 2011.

(51) Int. Cl. G06Q 40/04

(52) U.S. Cl. CPC G06Q 40/04
USPC 705/37

(57) ABSTRACT

The present specification provides a high availability system. In one aspect a replicator is situated between a plurality of servers and a network. Each server is configured to execute a plurality of identical message processors. The replicator is configured to forward messages to two or more of the identical message processors, and to accept a response to the message as being valid if there is a quorum of identical responses.

### CROSS-REFERENCE TO RELATED APPLICATION

This application claims priority to of U.S. Patent Application No.61/566,772 filed Dec. 5, 2011, the contents of which are incorporated herein by reference.

### FIELD

The present specification relates generally to computing devices and more specifically relates to computing devices for processing data records representing financial instruments.

### BACKGROUND

Electronic trading is common, however the diverse range of types and processing methodologies of data records that represent financial instruments continues to place significant processing burdens on computer hardware that is configured to process those data records. Indeed, while electronic financial transactions offer many advantages, it has also had the result of making financial markets extremely complex and fast moving, with the ability to move huge amounts of capital in less than a second. Furthermore, multiple systems often run in parallel. For example, a particular entity can be issuing a variety of different equity and debt instruments which are administered on disparate systems. However such complex systems are prone to failures, be they electronic, mechanical, network or even human errors. Despite existing fail-safes, it is believed those fail-safes remain insufficient.

### SUMMARY

In accordance with an aspect of the specification, there is provided a system for processing data records representing financial instruments. The system includes a debt trading engine configured to execute orders received from a client machine. The system also includes an equity trading engine configured to execute orders received from a client machine. Furthermore, the system includes a debt feed device configured to send debt rating data. The debt rating data includes data corresponding to debt issues received from the debt trading engine. In addition, the system includes an equity feed device configured to send equity data. The equity data includes data corresponding to equity instruments received from the equity trading engine. The system further includes a rating engine connected to the debt feed device and the equity feed device. The rating engine is configured to receive the debt rating data and the equity data. The rating engine is further configured to discard at least one of the debt issues or at least one of the equity instruments, wherein the at least one of the debt issues or at least one of the equity instruments is without a counterpart. The rating engine is further configured to create subsets of remaining debt issues, each of the subsets having a predefined debt rating. The rating engine is further configured to sort remaining equity instruments according to the subsets and an associated counterpart debt issue for each of the remaining equity instruments. In addition, the rating engine is configured to generate an index based on the subsets of the remaining equity instruments. The rating engine is also configured to receive exception handling criteria for comparing the debt rating data and the equity data to determine if the exception handling criteria is satisfied. The rating engine is further configured to initiate an exception handling protocol if the exception handling criteria is satisfied.

The debt feed device may be configured to send a continuous feed.

The debt feed device may be a server of a debt-rating agency.

The equity feed device may be configured to send a continuous feed.

The equity feed device is a server of a stock exchange.

The rating engine may be further configured to normalize debt ratings from the debt rating data for multiple instances of the same debt issues.

The debt feed device may be further configured to normalize debt ratings from the debt rating data for multiple instances of the same debt issues.

The rating engine may be further configured to normalize equity pricings from the equity data for multiple instances of the same equity instruments.

The equity feed device may be further configured to normalize equity ratings from the equity data for multiple instances of the same equity instruments.

The system may further include a client machine for receiving the index from the rating engine.

In accordance with another aspect of the specification, there is provided a method of processing data records representing financial instruments. The method involves receiving, from a debt feed device, debt rating data at a rating engine, the debt rating data comprising data corresponding to debt issues. The method further involves receiving, from an equity feed device, equity data at the rating engine, the equity data comprising data corresponding to equity instruments. In addition, the method involves receiving exception handling criteria at the rating engine. Furthermore, the method involves comparing the debt rating data and the equity data to determine if the exception handling criteria is satisfied. The method further involves initiating an exception handling protocol if the exception handling criteria is satisfied.

Receiving the debt rating data may involve receiving a continuous feed.

Receiving the continuous feed may involve receiving the continuous feed form a debt-rating agency.

Receiving the equity data may involve receiving a continuous feed.

Receiving the continuous feed may involve receiving the continuous feed form a stock exchange.

The method may further involve normalizing debt ratings from the debt rating data for multiple instances of the same debt issues.

Normalizing may involve normalizing at the debt feed device.

Normalizing may involve normalizing at the rating engine.

The method may also involve normalizing equity pricings from the equity data for multiple instances of the same equity instruments.

Normalizing may involve normalizing at the equity feed device.

Normalizing may involve normalizing at the rating engine.

The method may further involve sending the index to a client machine.

In accordance with another aspect of the specification, there is provided a method of exception handling. The method involves receiving exception handling criteria at the rating engine. The method also involves determining if the exception handling criteria is satisfied. In addition, the method involves initiating an exception handling protocol if the exception handling criteria is satisfied.

In accordance with another aspect of the specification, there is provided a system for processing data records representing financial instruments. The system includes a debt feed device configured to send debt rating data. The debt rating data includes data corresponding to debt issues. The system further includes an equity feed device configured to send equity data. The equity data includes data corresponding to equity instruments. The system also includes a rating engine connected to the debt feed device and the equity feed device. The rating engine is configured to receive the debt rating data and the equity data. The rating engine is further configured to discard at least one issue. The at least one issue includes at least one of the debt issues or at least one of the equity instruments, and wherein the at least one issue is without a counterpart issue. The rating engine is further configured to create subsets of remaining debt issues. Each of the subsets includes a predefined debt rating, the rating engine is further configured to sort remaining equity instruments according to the subsets and an associated counterpart debt issue for each of the remaining equity instruments. The rating engine is further configured to generate an index based on the subsets of the remaining equity instruments.

The debt feed device may be configured to send a continuous feed.

The debt feed device may be a server of a debt-rating agency.

The equity feed device may be configured to send a continuous feed.

The equity feed device may be a server of a stock exchange.

The rating engine may be further configured to normalize debt ratings from the debt rating data for multiple instances of the same debt issues.

The debt feed device may be further configured to normalize debt ratings from the debt rating data for multiple instances of the same debt issues.

The rating engine may be further configured to normalize equity pricings from the equity data for multiple instances of the same equity instruments.

The equity feed device may be further configured to normalize equity ratings from the equity data for multiple instances of the same equity instruments.

The system may further include a client machine for receiving the index from the rating engine.

In accordance with another aspect of the specification, there is provided a method of processing data records representing financial instruments. The method involves receiving, from a debt feed device, debt rating data at a rating engine. The debt rating data includes data corresponding to debt issues. The method also involves receiving, from an equity feed device, equity data at the rating engine. The equity data includes data corresponding to equity instruments. The method further involves discarding at least one issue, wherein the at least one issue comprises at least one of the debt issues or at least one the equity instruments, and wherein the at least one issue is without a counterpart issue. In addition, the method involves creating, at the rating engine, subsets of remaining debt issues, each of the subsets having a predefined debt rating. Furthermore, the method involves sorting, at the rating engine, remaining equity instruments according to the subsets and an associated counterpart debt issue for each of the remaining equity instruments. Also, the method involves generating an index based on the subsets of the remaining equity instruments.

Receiving the debt rating data may involve receiving a continuous feed.

Receiving the continuous feed may involve receiving the continuous feed form a debt-rating agency.

Receiving the equity data may involve receiving a continuous feed.

Receiving the continuous feed may involve receiving the continuous feed form a stock exchange.

The method may further involve normalizing debt ratings from the debt rating data for multiple instances of the same debt issues.

Normalizing may involve normalizing at the debt feed device.

Normalizing may involve normalizing at the rating engine.

The method may further involve normalizing equity pricings from the equity data for multiple instances of the same equity instruments.

Normalizing may involve normalizing at the equity feed device.

Normalizing involve normalizing at the rating engine.

The method may further involve sending the index to a client machine.

In accordance with another aspect of the specification, there is provided a non-transitory computer readable medium encoded with codes. The codes direct a processor to receive, from a debt feed device, debt rating data at a rating engine. The debt rating data including data corresponding to debt issues. In addition, the codes direct a processor to receive, from an equity feed device, equity data at the rating engine, the equity data comprising data corresponding to equity instruments. Furthermore, the codes direct a processor to receive exception handling criteria at the rating engine. The codes further direct a processor to compare the debt rating data and the equity data to determine if the exception handling criteria is satisfied. The codes also direct a processor to initiate an exception handling protocol if the exception handling criteria is satisfied.

### BRIEF DESCRIPTION OF THE DRAWINGS

FIG. 1 is a schematic representation of an integrated system for processing data records representing financial instruments across different reporting devices.

FIG. 2 is a flow chart depicting a method for processing data records representing financial instruments.

FIG. 3 is a schematic representation of a closed-loop system for processing data records across different trading engines and reporting devices.

FIG. 4 is a flow chart depicting a method for operating the system of FIG. 3.

### DETAILED DESCRIPTION OF THE EMBODIMENTS

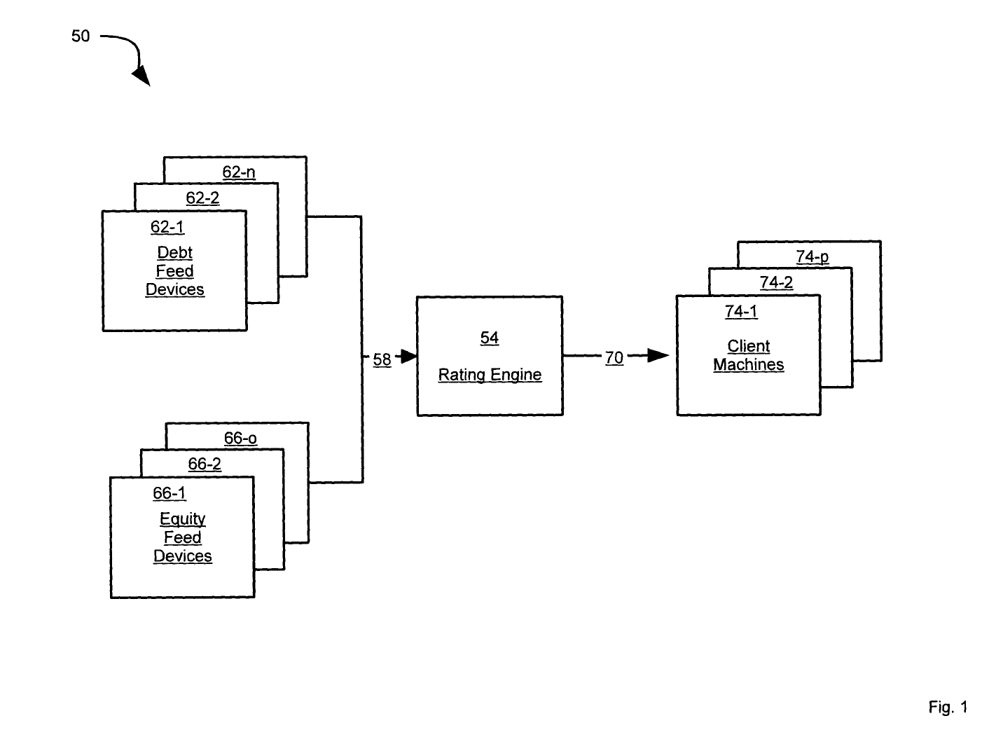

FIG. 1 a schematic representation of a non-limiting example of a system 50 for processing data records representing financial instruments. System 50 comprises a rating engine 54 that connects, via a link 58, to one or more debt feed devices 62-1, 62-2 . . . 62-n for providing debt-rating data. Generically, these are referred to as “debt feed device 62” and collectively they are referred to as “debt feed devices 62”. This nomenclature is used elsewhere herein. Rating engine 54 also connects, via link 58, to one or more equity feed devices 66. Rating engine 54 also connects, via a second link 70, to a plurality of client machines 74.

Rating engine 54 can be based on any desired server-type computing environment, including appropriate configurations of one or more central processing units (CPUs) configured to control and interact with memory (including volatile memory such as Random Access Memory, and non-volatile memory such as hard disk drives or FLASH drives, or a Redundant Array of Inexpensive Disks (RAID) or cloud-based storage), network interfaces (to connect to link 58 and link 70). Rating engine 54 can also be configured to include input devices such as a keyboard or pointing device or output devices such as a monitor or any of or all of them, to permit local interaction. Other types of hardware configurations for rating engine 54 are contemplated. For example, rating engine 54 can also be implemented as part of a cloud-based computing solution, whereby the functionality of rating engine 54 is implemented as one or more virtual machines executing at a single data center or in a mirrored form across a plurality of data centers. The software environment of rating engine 54 can also include remote access capabilities in lieu of, or in addition to, any local input devices or local output devices. Any desired or suitable operating system can be used in the computing environment of rating engine 54. In general rating engine 54 is configured to perform rating of various equities according to debt based on data received from debt feed devices 62 and equity feed devices 66.

Debt feed devices 62 can be based on any suitable server-type computing environment, much along the possible lines of the computing environments described in relation to rating engine 54. Each debt feed device 62 can provide debt rating feeds from, for example, one or more debt-rating agencies such as Dominion Bond Rating Service (Canada); Standard & Poor's (U.S.); A. M. Best (U.S.); Baycorp Advantage (Australia); Credo line (UA); Dagong Global (Peoples Republic of China); Egan-Jones Rating Company (U.S.); Fitch Ratings (Dual-headquartered U.S./UK); Japan Credit Rating Agency, Ltd. (Japan); Moody's Investors Service (U.S.); Muros Ratings (Russia alternative rating agency). Accordingly it will be understood that debt feed devices 62 can be distributed across the globe. Each debt feed device 62 can be hosted directly by such debt-rating agencies, or they can be hosted by another entity that publishes or distributes such debt-rating feeds on behalf of those agencies.

Equity feed devices 66 can be based on any suitable server-type computing environment, much along the possible lines of the computing environments described in relation to rating engine 54. Each equity feed device 66 can provide stock or equity market pricing, for example, from one or more equity feeds such as New York Stock Exchange (NYSE), NASDAQ, Toronto Stock Exchange, Amsterdam Stock Exchange, London Stock Exchange, Paris Bourse, Deutsche Börse, Nigerian Stock Exchange, Singapore Exchange, Tokyo Stock Exchange, Hong Kong Stock Exchange, Shanghai Stock Exchange, Bombay Stock Exchange, BM&F Bovespa, BMV. Accordingly it will be understood that equity feed devices 66 can be distributed across the globe. Each equity feed device 66 can be hosted directly by such various exchanges, or they can be hosted by another entity that publishes or distributes such equity pricing feeds on behalf of those exchanges.

Client machines 74 can be based on any suitable computing environment. The use of the term “client” in the context of client machines 74 is not particularly limited and reflects the relationship between machines 74 and rating engine 54. For example, one or more of client machines 74 can be traditional client computers, such as a desktop computer, a laptop computer, or mobile computing device that receives and publishes and displays the rating feed affected by rating engine 54. One or more client machines 74 can also be server-type computing devices configured to generate electronic data records representing instructions to trade debt instruments or equities or both, with such instructions being sent to appropriate trading engines that are configured to execute electronic trades of debt instruments or equities. As used herein the term debt instrument can comprise bonds or similar debt instruments. As used herein the term equity can comprise stocks or similar equity instruments (also referred to as equity instruments). Client machines 74 can be operated or hosted by financial institutions, retail investors, or any other entity having an interest in the feed generated by rating engine 54.

Based on the foregoing discussion of rating engine 54, debt feed devices 62, equity feed devices 66 and client machines 74, it will now be understood that link 58 and link 70 can be implemented with a networking infrastructure that provides appropriate connectivity. Indeed link 58 and link 70 may be implemented as a single link, or as two separate links, as shown. Furthermore link 58 itself may be implemented as a plurality of links to each of the individual debt feed devices 62 and each of the individual equity feed devices 66. By the same token, link 70 may be implemented as a plurality of links to each individual client machine 74. Thus link 58 and link 70 can comprise any combination of networking infrastructures to connect debt feed devices 62, equity feed devices 66, and client machines 74. Such networking infrastructures may thus include one or more of a local area network (LAN) and a wide area network (WAN) such as the Internet or the like. The networking interfaces in one or more of rating engine 54, debt feed devices 62, equity feed devices 66 and client machines 74 can also be configured to address latencies and other connectivity issues that may result in lag or other asychronicities over link 58 and link 70 that can impact the ability to provide substantially real-time rating by rating engine 54, as will become apparent from further discussion below.

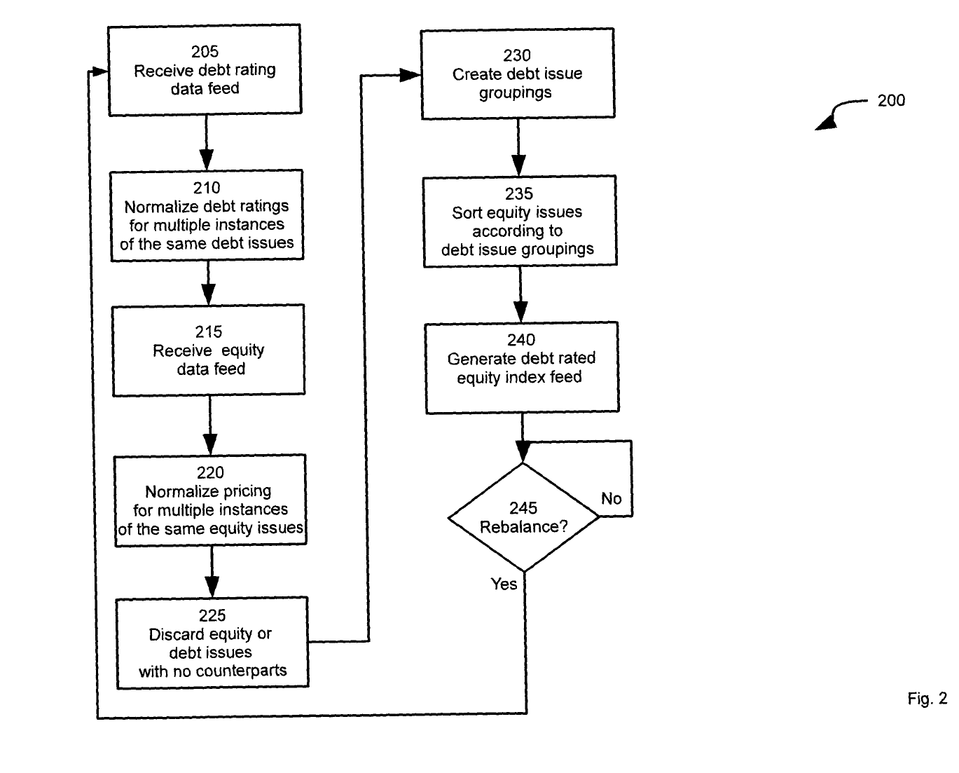

Referring now to FIG. 2, a flowchart depicting a method for processing data records representing financial instruments is indicated generally at 200. Method 200 is one way in which rating engine 54 can be configured. It is to be emphasized, however, that method 200 and need not be performed in the exact sequence as shown; and likewise various blocks may be performed in parallel rather than in sequence; hence the elements of method 200 are referred to herein as “blocks” rather than “steps”. It is also to be understood, however, that method 200 can be implemented on variations of system 50 as well.

Block 205 thus comprises receiving a debt rating data feed. In the present embodiment, the debt rating data feed provides debt rating data to the rating engine 54 from a debt feed device 62. The debt rating data includes data corresponding to debt issues. In relation to system 50, it is assumed that such one or more debt rating data feeds are received at rating engine 54 from one or more debt feed services, also referred to as debt feed devices 62 via link 58. Table I shows a non-limiting illustrative example of what a feed that could be received at block 205.

TABLE I
Example debt rating data feed received at block 205

| Source | Debt | | | |
|---|---|---|---|---|
| (Debt Feed | Instrument | | | Rating |
| Device) | Identifier | Issuing Entity | Debt Rating | Agency |
| 62-1 | 0001 | ABC Co. | AAA⁺ | JKL Rating |
| | | | | Agency |
| 62-1 | 0002 | BCD Co. | AA | JKL Rating |
| | | | | Agency |
| 62-1 | 0003 | DEF Co. | BBB | JKL Rating |
| | | | | Agency |
| 62-2 | 0001 | ABC Co. | AAA⁻ | LMN Rating |
| | | | | Agency |
| 62-2 | 0004 | EFG Co. | CCC | LMN Rating |
| | | | | Agency |
| 62-n | 0005 | GHI Co. | CCC | MNO Rating |
| | | | | Agency |
| 62-n | 0006 | Government of | CCC | MNO Rating |
| | | Bratislavmovia | | Agency |

In Table I, Column 1, labeled “Source” represents a specific debt feed device 62 shown in FIG. 1 as discussed above. Column 2, labeled “Debt Instrument Identifier” represents a unique debt instrument identifier, such as a Committee on Uniform Security Identification Procedures (CUSIP). Column 3, labeled “Issuing Entity”, identifies the particular government, corporation, or other entity that issued the particular debt instrument. (Note the Issuing Entity is typically derivable from the CUSIP anyway and so this column may be obviated). Column 4, labeled “Debt Rating”, identifies a debt rating that has been assigned to the instrument identified in Column 2, where such a debt rating represents an assessment of the credit worthiness of the instrument identified in Column 2. Column 5, labeled “Debt Rating Agency” identifies the organization that provided the Debt Rating assessment in Column 4. Other columns that could be included comprise year of issue and coupon and any other data associated with a particular debt instrument, though this information is typically derivable by a lookup to an external database that maintains such information (not shown) that is indexed using the unique debt instrument identifier from Column 2.

It is to be emphasized that the contents of Table I are for illustrative purposes only, and are not intended to reflect actual existing or historical debt instruments, issuing entities, debt ratings, or rating agencies. However, the example contents of Table I will be referred to hereafter to further explanation of the present specification.

Block 210 comprises normalizing debt ratings for multiple instances of the same debt issues. Block 210 can be eliminated where the debt feed device(s) 62 have already normalized debt ratings, or where the feed from debt feed devices(s) 62 contain no inconsistencies. However, note that, as an example in Table I, Debt Instrument 0001 has been rated AAA+ by JKL Rating Agency (See first row of Table I) and has been rated AAA− by LMN Rating Agency (See fourth row of Table I). Accordingly, at block 210, these two different ratings would be normalized into a single rating. Such difference in ratings can occur for various reasons, such as the use of different rating scales, or the usage of different rating criteria, or different times when such ratings are generated by different rating agencies. Indeed, it is common for such ratings to be done manually, or by a committee, and so a level of subjectivity between different rating agencies can be common. Various programming operations can be used to effect such normalization. For example, where the two different ratings (e.g. “AAA+” and “AAA−”) are on the same rating scale, then a simple averaging of the two can be performed by assigning a numeric equivalent to each item on the scale, performing an averaging operation of those numbers, and then converting back from the numeric equivalent to the letter scale. An averaging (AAA⁺+AAA⁻/2) according to this example results in an “AAA” rating. Other normalization programming operations can include a more statistical averaging. For example, where there are more than two different ratings, then any rating that drastically distorts an averaging operation can be discarded from the averaging operation. Other types of normalizing operations will now occur to those skilled in the art.

Block 215 comprises receiving an equity data feed. In the present embodiment, the equity data feed provides equity data to the rating engine 54 from an equity feed device 66. The equity data includes data corresponding to equity instruments. In relation to system 50, it is assumed that such one or more equity data feeds are received at rating engine 54 from one or more equity feed devices 66 via link 58. Table II shows a non-limiting illustrative example of what a feed that could be received at block 210.

TABLE II
Example equity pricing feed received at block 205

| Source | Equity | | | |
|---|---|---|---|---|
| (Equity Feed | Instrument | | | Pricing |
| Device) | Identifier | Issuing Entity | Equity Pricing | Entity |
| 66-1 | ABC-N | ABC Co. | $0.20 | NOP Stock |
| | | | | Exchange |
| 66-1 | BCD | BCD Co. | $400.00 | NOP Stock |
| | | | | Exchange |
| 66-1 | DEF | DEF Co. | $200.00 | NOP Stock |
| | | | | Exchange |
| 66-2 | ABC-O | ABC Co. | $0.1983 | OPQ Stock |
| | | | | Exchange |
| 66-2 | EFG | EFG Co. | $700.00 | OPQ Stock |
| | | | | Exchange |
| 66-n | GHI | GHI Co. | $.22 | PQR Stock |
| | | | | Exchange |
| 66-n | IJK | IJK Co. | $43.00 | PQR Stock |
| | | | | Exchange |

In Table II, Column 1, labeled “Source” represents a specific equity feed device 66 shown in FIG. 1 as discussed above. Column 2, labeled “Equity Instrument Identifier” represents a unique equity identifier, such as a Stock Symbol. Column 3, labeled “Issuing Entity”, identifies the particular corporation, or other entity that issued the particular equity. (Note the Issuing Entity is typically derivable from the stock symbol anyway and so this column may be obviated). Column 4, labeled “Equity Pricing”, identifies a pricing that has been assigned to the instrument identified in Column 2, where such a pricing can represent a current best bid offer (BBO), or a bid/ask price, or the like, for the equity instrument identified in Column 2. Column 5, labeled “Pricing Entity” identifies the organization that provided the Pricing in Column 4, typically the name of a particular stock exchange where the equity instrument in Column 2 is being traded. Other columns that could be included, though such information is typically derivable by a lookup to an external database that maintains such information (not shown) that is indexed using the unique equity instrument identifier from Column 2.

It is to be emphasized that the contents of Table II are for illustrative purposes only, and are not intended to reflect actual existing or historical equity instruments, issuing entities, pricing, or pricing entities. However, the example contents of Table II will be referred to hereafter to further explanation of the present specification.

Block 220 comprises normalizing equity pricings for multiple instances of the same equity instruments. Block 220 can be eliminated where the equity feed device(s) 66 have already normalized equity pricing ratings, or where the feed from equity feed devices(s) 66 contain no inconsistencies. However, note that, as an example in Table II, Equity Instrument ABC-N has been given the price $0.20 by the NOP Stock Exchange (See first row of Table II), while Equity Instrument ABC-O has been given the price $0.1983 by the OPQ Stock Exchange (See fourth row of Table II). It can be noted that the particular equity instrument is identical, though the suffix “-N”, indicates that that the particular equity instrument is being traded on the NOP Stock Exchange, while the “-O” indicates that the same equity instrument is being traded on the OPQ Stock Exchange. The reasons for differences between the pricing on each exchange can be multifold. For example, the NOP Exchange may operate in a first currency, while the OPQ Exchange operates in a second currency, and so the normalization operation must normalize around a common currency. As another example, different pricing entities may round pricing in different ways, or to different degrees of precision. As another example, different pricing entities may update their feeds at different times, so minor fluctuations may exist due to time lags. Other reasons for inconsistencies can exist. For purposes of further discussion, we will assume that ABC-N at $0.20 and ABC-O at $0.1983 are expressed in the same currency and so as an example, normalization, an average will be taken to result in a normalized single stock symbol ABC having a price of $0.19915.

Accordingly, at block 220, these two different pricings would be normalized into a common price. Various programming operations can be used to effect such normalization. For example, where the differences are due to exchange rate differences, then the normalizing can be based on an exchange rate normalization operation (as discussed). Averaging and statistical averaging can also be used. Other types of normalizing operations will now occur to those skilled in the art.

Block 225 comprises discarding equity instruments or debt issues from each of the feeds that have no counterpart issue. The means by which block 225 is effected is not particularly limited and can be performed by filtering the incoming debt rating data or equity data. Alternatively, discarding equity instruments can involve deleting data records store in the rating engine 54. For example, the last row of Table I refers to a debt instrument with an debt instrument identifier of 0006 issued by the Government of Bratislavmovia. As there is no equity instrument in Table II issued by the Government of Bratislavmovia, (and indeed Governments do not issue equities in any event), this last entry in Table I is discarded. As another example, the last row of Table II refers to an equity instrument with an equity instrument identifier of IJK issued by IJK Co. As there is no debt instrument in Table I issued by IJK Co., this last entry in Table II is discarded. It is to be appreciated, with the benefit of this description, that discarding the equity instruments or debt issues that have no counterpart issue will reduce burden on the rating engine 54. For example, a processor of the rating engine 54 would perform fewer operations during the execution of the following blocks since fewer issues would are processed. Furthermore, the memory requirements of the rating engine 54 are reduced since fewer data records representing issues are stored.

Table III shows a non-limiting example of the result of performance of Block 225, wherein a single row for ABC Co. is provided that includes normalized equity pricing of $0.19915 and a normalized debt rating of AAA; and wherein entries for IJK Co. and the Government of Bratislavmovia are omitted altogether.

TABLE III
Example results of performance of Block 225 based on
Table I and Table II

| | Equity | | Debt | |
|---|---|---|---|---|
| Issuing | Instrument | | Instrument | |
| Entity | Identifier | Equity Pricing | Identifier | Debt Rating |
| ABC Co. | ABC | ($0.20 + $0.1983)/ | 0001 | (AAA⁺ + |
| | | 2 = $0.19915 | | AAA)/2 = |
| | | | | AAA |
| BCD Co. | BCD | $400.00 | 0002 | AA |
| DEF Co. | DEF | $200.00 | 0003 | BBB |
| EFG Co. | EFG | $700.00 | 0004 | CCC |
| GHI Co. | GHI | $0.22 | 0005 | CCC |

Block 230 comprises creating debt issue groupings. The debt issue groupings are subsets of all the debt issues stored in the rating engine 54. The means by which block 230 is effected is not particularly limited, and can be predefined or can be based on the logical groupings of available types of debt ratings from the results of block 225. In a present non-limiting example embodiment, it is contemplated that the debt issue groupings are grouped into predefined subsets of debt rating such as “A”, “B” and “C” types.

Block 235 comprises sorting equity instruments according to debt issue groupings. The remaining equity instruments which have not been discarded are sorted according to the predefined subsets and a corresponding counterpart debt issue for each of the equity instruments. In particular, the counterpart equity instrument of each remaining debt issue is sorted into similar subsets as the debt issue groupings. Continuing with the example groupings of “A”, “B” and “C”, Table IV shows the results of performance of block 235 based on receiving the contents of Table III.

TABLE IV
Example results of performance of Block 235 based
on the contents of Table III

| | | Equity | | Debt | |
|---|---|---|---|---|---|
| | Issuing | Instrument | | Instrument | Debt |
| Grouping | Entity | Identifier | Equity Pricing | Identifier | Rating |
| A | BCD Co. | BCD | $400.00 | 0002 | AA |
| | ABC Co. | ABC | $0.19915 | 0001 | AAA |
| B | DEF Co. | DEF | $200.00 | 0003 | BBB |
| C | EFG Co. | EFG | $700.00 | 0004 | CCC |
| | GHI Co. | GHI | $0.22 | 0005 | CCC |

Explaining Table IV in further detail, instruments issued by BCD Co. and ABC Co. are grouped under “A” because their debt instruments have an “AA” or “AAA” rating; instruments issued by DEF Co. are grouped under “B” because its instruments have a “BBB” rating; and instruments issued by EFG Co. and GHI Co. are grouped under “C” because their instruments each have a “CCC” rating.

Block 240 comprises generating a debt rated index equity feed based on the results from block 235. In the present embodiment, the index is generated based on the predefined subsets with which the equity instruments were associated. The contents of the index from block 240 can be based on the contents of Table IV, or any variation thereon, where the equity pricing for a given issuing entity is grouped according to the groupings defined at block 230. The feed generated at block 240 is then sent to client machines 74. It is to be emphasized that the present embodiment is a non-limiting embodiment only and that Table IV can include hundreds or thousands of issuing entities. Furthermore, it is to be appreciated by a person of skill in the art that as the number of issuing entities scales, manually performing the processes outlined in the above described blocks is impractical so as to be meaningful or, at a certain point of scaling, even operative.

Block 245 comprises a determination as to whether or not to rebalance the index generated at block 240. A “yes” determination leads to block 205 where method 200 begins anew. A “no” determination leads to a wait state. The criteria for reaching a “yes” at block 245 is not particularly limited, and can be based on a time interval, such as a matter of minutes, hours, day, or days. Alternative criteria can include examining feeds from debt feed devices 62 or equity feed devices 66 or all of them and triggering a “yes” if there is a change beyond a predefined threshold of a particular equity pricing or a particular debt rating.

Returning now to block 240, as discussed above the equity feed generated at block 240 is sent to client machines 74. Where client machines 74 are workstations or mobile devices or other computing devices with displays, the feed can simply be displayed. As will be discussed further below in relation to the system 50a, where client machines 74 are servers or other computing devices configured for algorithmic trading, then client machines 74 can be configured to trigger an exception handling routine based on a satisfaction of certain criteria, such as to issue electronic instructions to electronic trading platforms (not shown) to buy or sell a given equity or a given debt instrument or both. For example, an examination of ABC Co. under Grouping “A” of Table IV it can be noted that the equity pricing is extremely low, and meanwhile the debt rating is extremely high. An algorithmic trading operation within a client machine 74 can be configured to automatically sell ABC Co.'s debt instruments since the debt rating is high in relation to the perceived market value of ABC Co.'s equity pricing, suggesting a possible error or problem with the accuracy of the debt rating. Other algorithmic trading operations can be more sophisticated, or set to triggers for different conditions. Further examples of exception handling will be discussed further below in relation to system 50a.

It is to be emphasized that the examples in Table I, Table II, Table III and Table IV are intentionally simplified for illustrative purposes. It is contemplated that system 50 can be scaled to process hundreds of thousands of records from different data feeds from around the world in order to provide a simplified debt rated equity index of the type shown in Table IV. A more complex set of example data that can be received at block 205, block 215 and which can be generated at block 240 based on the more complex set, is provided below.

While the foregoing provides certain non-limiting example embodiments, it should be understood that combinations, subsets, and variations of the foregoing are contemplated.

The present specification thus provides a novel system for processing data records representing financial instruments. Since debt instruments and equity instruments issued by the same entity can each represent an overall health of that entity, a significant mismatch between ratings and pricing can be used according to the teachings herein to make more informed financial decisions regarding whether or not a particular debt instrument or a particular equity instrument is over-valued or under-valued. Such a mismatch can be particularly prone to occur on debt instruments, which are balanced infrequently and ratings are made based on subjective committees, in contrast to equity instruments which algorithmically can be traded quite quickly and rarely does an equity instruments value fall below the cash value of its underlying issuer. Accordingly, while an equity instrument pricing fall quickly reflecting overall financial trouble for its issuer, a corresponding debt instrument may maintain a positive rating for a period after the financial trouble has occurred, resulting in a mismatch between the published rating and an accurate rating. A converse financial effect can also occur. Accordingly, the present specification discloses a novel system for providing potential mitigation for such mismatches.

With these points in mind in other embodiments, the rating engine 54 or the client machines 74 can be further configured to provide a checksum or validation operation to verify the integrity data received in either the debt rating data feed or the equity data feed thereby assisting in identifying potential errors that can be used to invoke exception handling routines to mitigate effects of such errors. More specifically, a significant mismatch between ratings and pricing may used to generate one or more exception handling routines indicative of an error somewhere in the system. It is to be appreciated that any such error can lead to a cascade of errors in an online trading environment by triggering automatic errors to buy or sell financial instruments. Therefore, a mismatch satisfying predetermined exception handling criteria detected between the debt rating data and the equity data can alternatively be used as an indicator to aid in the detection of any such errors quickly so that corrective measures can be implemented before the error propagates throughout a financial system.

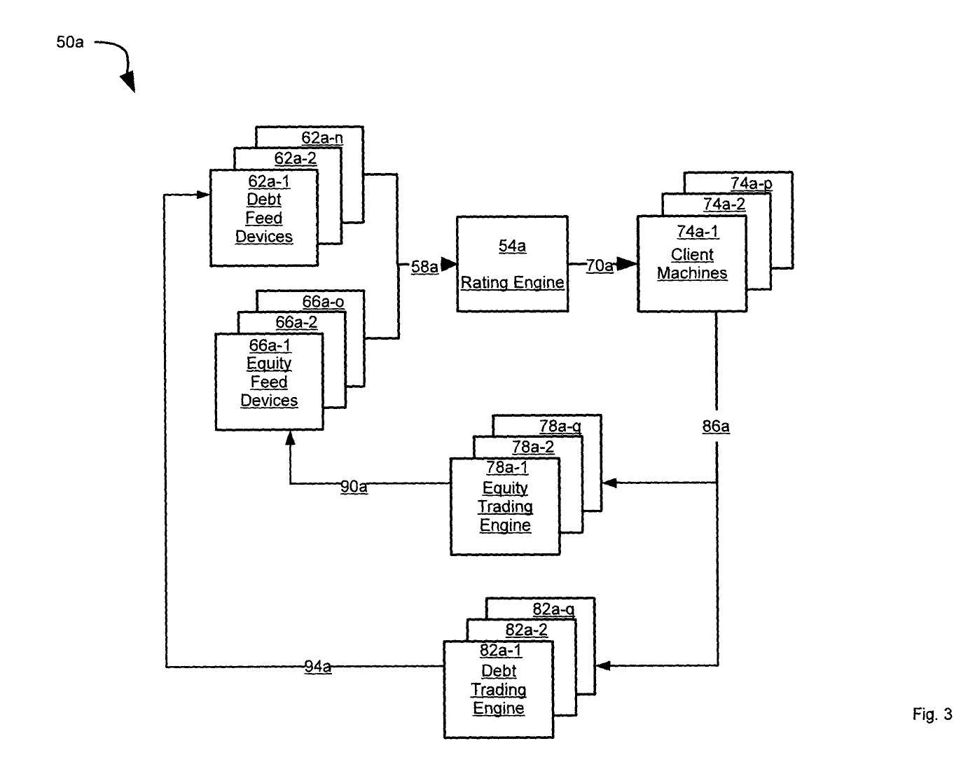

One example of such embodiments is shown in greater detail in FIG. 3 as system 50a. Since system 50a is a variant on system 50, elements in system 50a are shown with like reference characters to their counterpart in system 50, except in system 50a those elements are followed by the suffix “a”. Similar to the system 50, the system 50a includes debt feed devices 62a, equity feed devices 66a, links 58a and 70a, and a rating engine 54a generally configured for connecting to client machines 74a. In addition, the system 50a further includes equity trading engines 78a and debt trading engines 82a generally configured for connecting to the client machines 74a via a link 86a. The equity trading engines 78a are connected, via link 90a to the equity feed devices 66. Similarly, the debt trading engines 82a are connected, via link 94a to the debt feed devices 62.

The equity trading engines 78a can be based on any desired server-type computing environment, including those discussed above in connection with the rating engine 54. Indeed, such trading engines 78a can be based on any existing electronic equity exchanges, such as BATS™, DIRECT EDGE™, NASDAQ OMX™, and NYSE EURONEXT™, and so the remaining elements in system 50a can be configured to integrate therewith. The equity trading engines 78a are each generally configured to execute orders received from the client machines 74a to buy and sell equity instruments. In the present embodiment, each of the equity trading engines 78a is associated with a stock exchange. However, in other embodiments, the equity trading engines 78a can be associated with a plurality of stock exchanges or a portion of a stock exchange. When an order has been filled by one of the equity trading engines 78a, data associated with the filled order is sent to the equity feed devices 66a. The manner by which the data is sent is not particularly limited and can involve sending the data to every one of the equity feed devices 66a or to a selected number of the equity feed devices 66a.

Similarly, the debt trading engines 82a can be based on any desired server-type computing environment, including those discussed above in connection with the rating engine 54. Indeed, such debt trading engines 82a can be based on any existing electronic debt trading exchanges, such as SHORCAN™, CANTOR FITZGERALD™, TRADEWEB™, and MTS™, and so the remaining elements in system 50a can be configured to integrate therewith. The debt trading engines 82a are each generally configured to execute orders received from the client machines 74a to buy and sell debt issues. In the present embodiment, each debt trading engine 82a is associated with a secondary debt market.

In general terms, the system 50a is generally configured to operate in a closed loop with the client machines 74a where the system 50a facilitates trading of debt issues and equity instruments among the client machines 74a. It is to be re-emphasized that the system 50a described above is a non-limiting representation only. Notwithstanding the specific example, it is to be understood that other embodiments can be devised to perform the functions of the system 50a as described above. For example, although the present embodiment described includes the link 94a for sending data from the debt trading engines 82a to the debt feed devices 62a, other embodiments can omit this link. It is to be appreciated that in embodiments where the debt feed devices 62a rely solely, or in part, on data from debt rating agencies, the link 94a can be omitted since the link 94a would not serve any function in such embodiments. As another example, further components can be connected with the system 50a such as a separate machine for executing the exception handling operations.

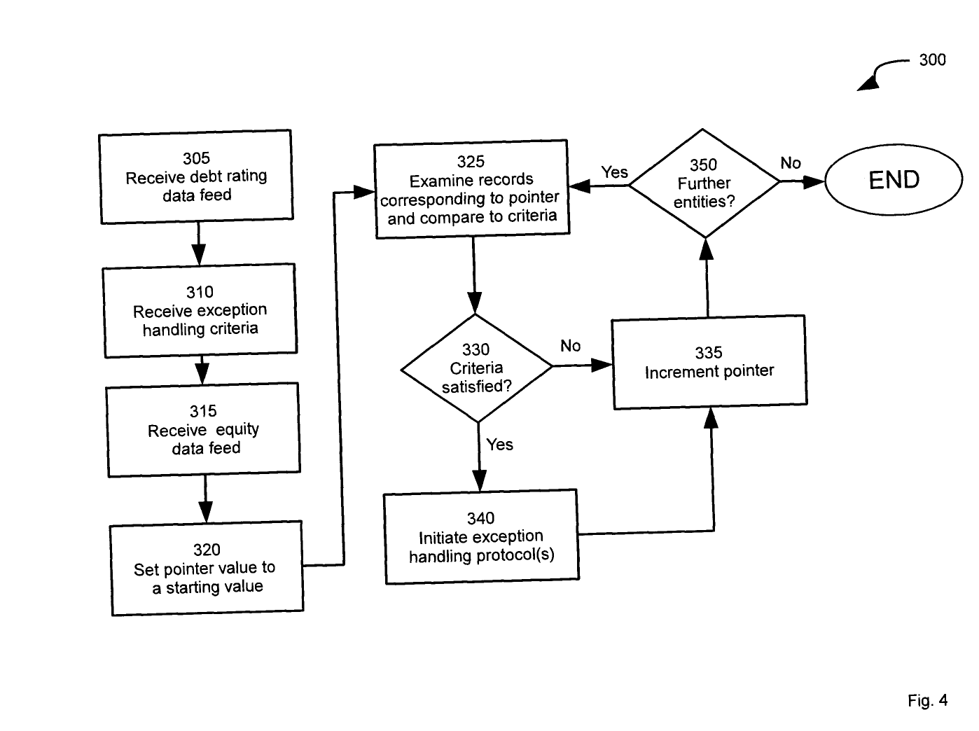

Referring now to FIG. 4, a method in accordance with another embodiment for processing data records representing financial instruments is represented in the form of a flow-chart and indicated generally at 300. In order to assist in the explanation of the method 300, it will be assumed that method 300 is performed using system 50a. The performance of the method 300 is not particularly limited and the method 300 can be performed by the rating engine 54a, the client machines 74a, or by any other component connected to system 50a. Furthermore, the following discussion of method 300 will lead to further understanding of system 50a and its various components as well as various methods that can be carried out on the system 50a. It is to be emphasized, that method 300 need not be performed in the exact sequence as shown; hence the elements of the method 300 are referred to herein as “blocks” rather than “steps”. For example, various blocks can be performed in parallel rather than in sequence.

Block 305 comprises receiving a debt rating data feed. The manner in which the data feed is received is not particularly limited and can include methods similar to those of block 205 described above.

Block 310 comprises receiving exception handling criteria. The manner in which the exception handling criteria is received is not particularly limited. For example, the exception handling criteria can be inherently programmed into the system 50a. Alternatively, the exception handling criteria can be adjusted on a periodic basis. For example, due to external policy considerations, the exception handling criteria may be adjusted by an administrator. In further embodiments, the exception handling criteria can be stored on an external machine connected to the system 50a and externally managed. Furthermore, the exception handling criteria can be unique to a specific equity instrument or a group of equity instruments. It is to be appreciated, with the benefit of this description, that by using unique exception handling criteria for different equity instruments, the system 50a can account for equity instruments which are known to be more volatile such that the exception handling criteria are not triggered due to the normal market fluctuations for a specific equity instrument known to be typically volatile.

For example, referring back to Table IV, equity instruments in Grouping A (BCD and ABC) would generally be expected to increase in value because of the good debt rating. If BCD is a stable equity instrument, the exception handling criteria can be set to a 2% decrease in the equity price value. However, if ABC is a more volatile equity instrument, market fluctuations may result in 2% increases and decreases in the equity price of ABC on a regular basis. Therefore, the exception handling criteria can be set to a 5% decrease for ABC to prevent satisfying the exception handling criteria due to normal market activity.

Block 315 comprises receiving an equity data feed. The manner in which the equity data feed is received is not particularly limited and can include methods similar to those of block 215 described above.

Block 320 comprises setting a pointer value to a starting value. The manner by which this is accomplished is not particularly limited. The pointer value is generally configured to keep track of a position within a database of records associated with an issuing entity.

Block 325 comprises examining records of the debt issue and the equity issue corresponding to the issuing entity identified by the value of the pointer. The records are compared to the exception handling criteria received at block 310. The examination and comparison process is not particularly limited. For example, in the present embodiment, the records can include debt rating data received from the execution of block 305 as well as equity data received from the execution of block 315. By comparing the debt rating data and the equity data, it can be determined whether a discrepancy exists for the issuing entity.

Next, block 330 comprises determining whether the exception handling criteria is satisfied. The manner by which this determination is made is not particularly limited. For example, in the present embodiment, the exception handling criteria can represent a maximum discrepancy between the debt rating data and the equity data. Therefore, if the discrepancy is greater than or equal to a threshold value, the method proceeds to block 340. Alternatively, if the discrepancy is not greater than the threshold value, the method proceeds to block 335.

It is to be re-emphasized that the description of block 330 is a non-limiting representation and that variations are contemplated. For example, the exception handling criteria can include a varying threshold for the discrepancy between the debt rating data and the equity data dependent on the issuing entity. It is to be understood that by varying the threshold for the discrepancy, the volatility associated with specific issuing entities can be accounted for to reduce the likelihood of satisfying the exception handling criteria by changes caused by normal market fluctuations associated with the specific issuing entity.

Block 340 comprises initiating at least one exception handling protocol. The exception handling protocol is not particularly limited and a wide variety of different protocols are contemplated. For example, the discrepancy between the debt rating data and the equity data can be used as an indicator that an error condition is present in messages sent from the client machines 74a to the equity trading engine 78a or the debt trading engine 82a. Once the error condition is recognized, the exception handling protocol can further cause the equity trading engine 78a and the debt trading engine 82a to halt further trading of the equity instrument and/or the debt issue. Alternatively, the exception handling protocol can also be configured to halt all trading completely to prevent a potential positive feedback loop leading to a market crash.

As another example of an exception handling protocol, the discrepancy between the debt rating data and the equity data can be used as an indicator that an error condition is present in messages sent to the debt feed devices 62a and the equity feed devices 66a. Once the error condition is recognized and the specific debt feed device 62a and/or the specific equity feed device 66a are identified, the exception handling protocol can further cause the equity trading engine 78a and the debt trading engine 82a to halt further trading of the equity instruments and/or the debt issues associates with the specific debt feed device 62a and/or the specific equity feed device 66a. Alternatively, the exception handling protocol can also be configured to stop sending problematic messages to the debt feed devices 62a and the equity feed devices 66a. It is to be appreciated that by not sending problematic messages to the debt feed devices 62a and the equity feed devices 66a, the accuracy of the debt rating data and the equity data will be reduced or the debt rating data and the equity data could be eliminated.

As another example of an exception handling protocol, the exception handling criteria can be used by the client machines 74a to trigger algorithmic trading as discussed above to buy or sell equity instruments or debt issues. By monitoring the discrepancy between the debt rating data and the equity data as an indicator of an expected price change of either the equity instrument or the debt issue associated with the issuing entity, the client machines 74a can optimize an algorithmic trading process to achieve greater returns.

As another example, the exception handling criteria can be used by the client machines 74a to trigger buying or to stop buying new debt issues coming to the market.

As another example of an exception handling protocol, the exception handling criteria can be used by the client machines 74a to search for an arbitrage between convertible debt securities and the underlying equity based on changes to the rating changes.

Block 335 comprises incrementing the pointer value to point at the next issuing entity in the database. The manner by which this is accomplished is not particularly limited. For example, each issuing entity can be associated with an identification number. Therefore, the pointer would be incremented by a value of one to point to the next issuing entity in the database in the present embodiment.

Block 350 comprises determining there are further issuing entities in the database. The manner by which this determination is made is not particularly limited. For example, in the present embodiment, the total number of issuing entities can be stored such that the pointer value is compared with the number of issuing entities. A determination that there are further issuing entities in the database would lead back to block 325. A determination that there are no further issuing entities in the database would end the method 300. It is to be appreciated, with the benefit of this description that the method 300 will continuously loop and walk through all the issuing entities in the database before making the determination that there are no other records to end the method 300.

It is to be re-emphasized that the method 300 is a non-limiting representation only. Notwithstanding the specific example, it is to be understood that other embodiments can be devised to perform the blocks of the method 300 as described above. For example, it is to be appreciated that there are several different methods to walk the database record. In particular, blocks 310, 330 and 340 can be modified to be working in parallel at the same time.

While specific embodiments have been described and illustrated, such embodiments should be considered illustrative only and should not serve to limit the accompanying claims.

1. A system for processing data records representing financial instruments, the system comprising:
a debt trading engine configured to execute orders received from a client machine;
an equity trading engine configured to execute orders received from a client machine;
a debt feed device configured to send debt rating data, the debt rating data comprising data corresponding to debt issues received from the debt trading engine;
an equity feed device configured to send equity data, the equity data comprising data corresponding to equity instruments received from the equity trading engine; and
a rating engine connected to the debt feed device and the equity feed device, the rating engine configured to receive the debt rating data and the equity data, the rating engine further configured to discard at least one of the debt issues or at least one of the equity instruments, wherein the at least one of the debt issues or at least one of the equity instruments is without a counterpart,
the rating engine further configured to create subsets of remaining debt issues, each of the subsets having a predefined debt rating, the rating engine further configured to sort remaining equity instruments according to the subsets and an associated counterpart debt issue for each of the remaining equity instruments, the rating engine further configured to generate an index based on the subsets of the remaining equity instruments,
the rating engine further configured to receive exception handling criteria for comparing the debt rating data and the equity data to determine if the exception handling criteria is satisfied,
the rating engine further configured to initiate an exception handling protocol if the exception handling criteria is satisfied.

2. (canceled)

3. The system of claim 1, wherein the debt feed device is a server of a debt-rating agency.

4. (canceled)

5. The system of claim 1, wherein the equity feed device is a server of a stock exchange.

6. The system of claim 1, wherein the rating engine is further configured to normalize debt ratings from the debt rating data for multiple instances of the same debt issues.

7. The system of claim 1, wherein the debt feed device is further configured to normalize debt ratings from the debt rating data for multiple instances of the same debt issues.

8. The system of claim 1, wherein the rating engine is further configured to normalize equity pricings from the equity data for multiple instances of the same equity instruments.

9. The system of claim 1, wherein the equity feed device is further configured to normalize equity ratings from the equity data for multiple instances of the same equity instruments.

10. The system of claim 1, further comprising a client machine for receiving the index from the rating engine.

11. A method of processing data records representing financial instruments, the method comprising:
receiving, from a debt feed device, debt rating data at a rating engine, the debt rating data comprising data corresponding to debt issues;
receiving, from an equity feed device, equity data at the rating engine, the equity data comprising data corresponding to equity instruments;
receiving exception handling criteria at the rating engine;
comparing the debt rating data and the equity data to determine if the exception handling criteria is satisfied; and
initiating an exception handling protocol if the exception handling criteria is satisfied.

12. The method according to claim 11, wherein receiving the debt rating data comprises receiving a continuous feed.

13. The method according to claim 12, wherein receiving the continuous feed comprises receiving the continuous feed form a debt-rating agency.

14. The method according to claim 11, wherein receiving the equity data comprises receiving a continuous feed.

15. The method according to claim 14, wherein receiving the continuous feed comprises receiving the continuous feed form a stock exchange.

16. The method according to claim 11, further comprising normalizing debt ratings from the debt rating data for multiple instances of the same debt issues.

17. The method according to claim 16, wherein normalizing comprises normalizing at the debt feed device.

18. The method according to claim 16, wherein normalizing comprises normalizing at the rating engine.

19. The method according to claim 11, further comprising normalizing equity pricings from the equity data for multiple instances of the same equity instruments.

20. The method according to claim 19, wherein normalizing comprises normalizing at the equity feed device.

21. The method according to claim 19, wherein normalizing comprises normalizing at the rating engine.

22. The method according to claim 11, further comprising sending the index to a client machine.

23. A method of exception handling, the method comprising:
receiving exception handling criteria at the rating engine;
determining if the exception handling criteria is satisfied; and
initiating an exception handling protocol if the exception handling criteria is satisfied.

24-46. (canceled)
